(19) United States
(12) Patent Application Publication
(10) Pub. No.: US 2024/0250235 A1
(43) Pub. Date: Jul. 25, 2024

(54) NON-AQUEOUS ELECTROLYTE SECONDARY BATTERY

(71) Applicant: Prime Planet Energy & Solutions, Inc., Tokyo (JP)

(72) Inventors: Hideaki FUJITA, Kyotanabe-shi (JP); Daisuke NISHIDE, Kobe-shi (JP); Yoshikazu MIYACHI, Kobe-shi (JP); Yuta TANAHASHI, Kobe-shi (JP)

(21) Appl. No.: 18/391,658

(22) Filed: Dec. 21, 2023

(30) Foreign Application Priority Data
Jan. 23, 2023 (JP) 2023-008078

(51) Int. Cl. H01M 4/131; H01M 4/48; H01M 10/056; H01M 10/0587

(52) U.S. Cl. CPC H01M 4/131; H01M 4/483; H01M 10/056; H01M 10/0587; H01M 2300/002; H01M 2300/0091

(57) ABSTRACT

The present disclosure relates to a non-aqueous electrolyte secondary battery including an electrode assembly and an electrolyte solution, wherein the electrode assembly includes a positive electrode plate, a separator, and a negative electrode plate, the electrolyte solution contains a Li salt, a solvent, and an additive agent, the positive electrode plate includes a positive electrode core body and a positive electrode active material layer, the negative electrode plate includes a negative electrode core body and a negative electrode active material layer, and in at least one of the positive electrode active material layer and the negative electrode active material layer, a ratio A/B is 1.4 or more and 2.6 or less.

### CROSS REFERENCE TO RELATED APPLICATIONS

This nonprovisional application is based on Japanese Patent Application No. 2023-008078 filed on Jan. 23, 2023 with the Japan Patent Office, the entire contents of which are hereby incorporated by reference.

### BACKGROUND OF THE INVENTION

### Field of the Invention

The present disclosure relates to a non-aqueous electrolyte secondary battery (hereinafter also referred to as a battery).

### Description of the Background Art

Japanese Patent Laying-Open No. 2019-192333 discloses a non-aqueous electrolyte secondary battery in which permeability of an electrolyte solution permeating from an end portion of a composite material layer in a negative electrode plate is set.

### SUMMARY OF THE INVENTION

When the non-aqueous electrolyte secondary battery is repeatedly charged and discharged, the temperature of a central portion in a width direction of an electrode assembly tends to be likely to be increased as compared with that of an end portion. As a result, reaction is concentrated on the portion having a high temperature and the reaction becomes non-uniform, with the result that a cell property may be deteriorated.

It is an object of the present disclosure to provide a non-aqueous electrolyte secondary battery to suppress deterioration of a cell property when repeatedly charged and discharged.

The present invention provides the following non-aqueous electrolyte secondary battery.

[1] A non-aqueous electrolyte secondary battery comprising an electrode assembly and an electrolyte solution, wherein
the electrode assembly includes a positive electrode plate, a separator, and a negative electrode plate,
the electrolyte solution contains a lithium salt, a solvent, and an additive agent,
the positive electrode plate includes a positive electrode core body and a positive electrode active material layer,
the negative electrode plate includes a negative electrode core body and a negative electrode active material layer, and
in at least one of the positive electrode active material layer and the negative electrode active material layer, a ratio A/B of a concentration A of a component originated from the additive agent in a region disposed on an end portion side in a width direction of the electrode assembly to a concentration B of the component originated from the additive agent in a region disposed in a central portion in the width direction of the electrode assembly is 1.4 or more and 2.6 or less.

[2] The non-aqueous electrolyte secondary battery according to [1], wherein a length of each of the positive electrode active material layer and the negative electrode active material layer in the width direction of the electrode assembly is 180 mm or more.

[3] The non-aqueous electrolyte secondary battery according to [1] or [2], wherein the additive agent includes at least one selected from a group consisting of LiBOB and LiFSO₃.

[4] The non-aqueous electrolyte secondary battery according to any one of [1] to [3], wherein at least one of the positive electrode active material layer and the negative electrode active material layer includes the additive agent.

[5] The non-aqueous electrolyte secondary battery according to any one of [1] to [4], wherein a thickness of each of the positive electrode active material layer and the negative electrode active material layer is 100 μm or more and 260 μm or less.

[6] The non-aqueous electrolyte secondary battery according to any one of [1] to [5], wherein the electrode assembly is a wound type.

[7] The non-aqueous electrolyte secondary battery according to any one of [1]to [5], wherein the electrode assembly is a stacked type.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary configuration of a non-aqueous electrolyte secondary battery in the present embodiment.

FIG. 2 is a schematic diagram showing an exemplary configuration of an electrode assembly in the present embodiment.

FIG. 3 is a schematic cross sectional view showing an exemplary configuration of the electrode assembly in the present embodiment.

FIG. 4 is a schematic diagram showing a layer configuration of a stack produced in an Example.

FIG. 5 is a schematic diagram illustrating a sample used to measure the concentration of a component originated from an additive agent in the Example.

### DESCRIPTION OF THE PREFERRED EMBODIMENTS

Hereinafter, embodiments of the present invention will be described with reference to figures, but the present invention is not limited to the below-described embodiments. In each of all the figures described below, a scale is appropriately adjusted to facilitate understanding of each component, and the scale of each component shown in the figures does not necessarily coincide with the actual scale of the component.

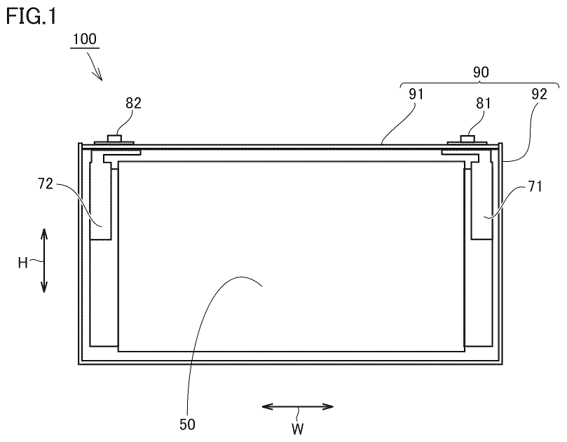

FIG. 1 is a schematic diagram showing an exemplary configuration of a non-aqueous electrolyte secondary battery in the present embodiment. A battery 100 may be used in any application. Battery 100 may be used as a main electric power supply or a motive power assisting electric power supply in an electrically powered vehicle or the like, for example. A battery module or a battery assembly may be formed by connecting a plurality of batteries 100. Battery 100 may have a rated capacity of, for example, 1 to 300 Ah.

Battery 100 includes an exterior package 90. Exterior package 90 has a prismatic shape (flat rectangular parallelepiped shape). Exterior package 90 may be composed of, for example, an aluminum (Al) alloy. Exterior package 90 stores an electrode assembly 50 and an electrolyte solution (not shown). That is, battery 100 includes electrode assembly 50 and the electrolyte solution.

Exterior package 90 may include, for example, a sealing plate 91 and an exterior container 92. Sealing plate 91 closes an opening of exterior container 92. For example, sealing plate 91 and exterior container 92 may be joined to each other by laser processing or the like. It should be noted that exterior package 90 may have any shape. Exterior package 90 may have, for example, a pouch shape or the like. That is, exterior package 90 may be a pouch composed of an Al laminate film or the like.

A positive electrode terminal 81 and a negative electrode terminal 82 are provided on sealing plate 91. Sealing plate 91 may be further provided with an injection opening (not shown), a gas-discharge valve (not shown), and the like. The electrolyte solution can be injected from the injection opening to inside of exterior package 90. The injection opening can be closed by, for example, a sealing plug or the like. A positive electrode current collecting member 71 connects positive electrode terminal 81 and electrode assembly 50. Positive electrode current collecting member 71 may be, for example, an Al plate or the like. A negative electrode current collecting member 72 connects negative electrode terminal 82 and electrode assembly 50. Negative electrode current collecting member 72 may be, for example, a copper (Cu) plate or the like.

Electrode assembly 50 includes a positive electrode plate, a separator, and a negative electrode plate. Electrode assembly 50 may be, for example, a wound type or a stacked type. When electrode assembly 50 is the wound type, electrode assembly 50 may be, for example, a stack of the positive electrode plate, the negative electrode plate, and the separator with a strip-like planar shape. The stack with the strip-like shape is spirally wound, thereby forming a wound assembly. The wound assembly may have a tubular shape, for example. By compressing the wound assembly having the tubular shape in the radial direction, electrode assembly 50 having a flat shape can be formed.

When electrode assembly 50 is the stacked type, electrode assembly 50 may be a stack of the positive electrode plate, the negative electrode plate, and the separator with a quadrangular planar shape. Electrode assembly 50 can be formed by stacking a plurality of the stacks in one predetermined direction.

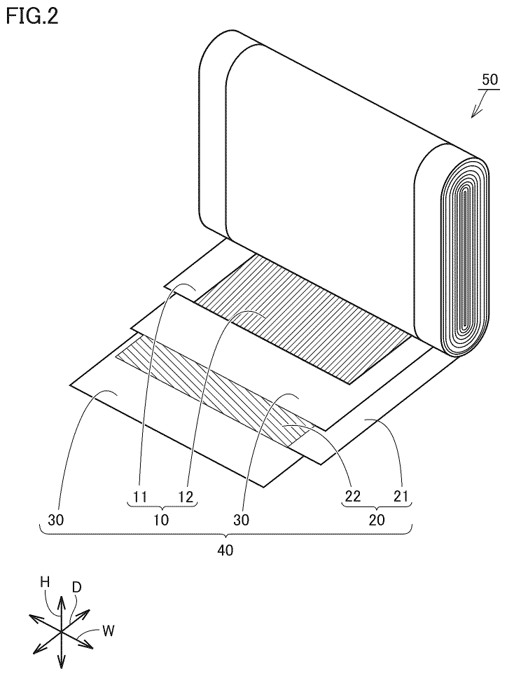

FIG. 2 is a schematic diagram showing an exemplary configuration of the electrode assembly in the present embodiment. Electrode assembly 50 of FIG. 2 is the wound type. Electrode assembly 50 includes a stack 40. Electrode assembly 50 may consist essentially of stack 40. Stack 40 includes a positive electrode plate 10, a negative electrode plate 20, and a separator 30. At least a portion of separator 30 is interposed between positive electrode plate 10 and negative electrode plate 20. Separator 30 separates positive electrode plate 10 and negative electrode plate 20 from each other. Stack 40 may include one separator 30 solely. Stack 40 may include two separators 30. For example, positive electrode plate 10 may be sandwiched between two separators 30. For example, negative electrode plate 20 may be sandwiched between two separators 30. Stack 40 may be formed by stacking separator 30 (first separator), negative electrode plate 20, separator 30 (second separator), and positive electrode plate 10 in this order, for example.

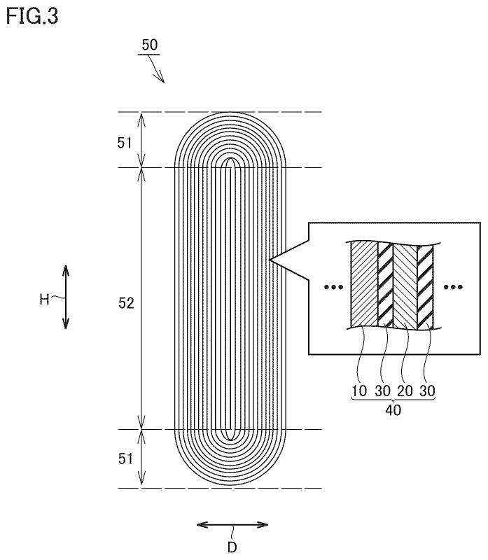

FIG. 3 is a schematic cross sectional view showing an exemplary configuration of the electrode assembly in the present embodiment. Electrode assembly 50 of FIG. 3 is the wound type. FIG. 3 shows a cross section orthogonal to a winding axis. Electrode assembly 50 includes curved portions 51 and a flat portion 52. At each of curved portions 51, stack 40 is curved. At curved portion 51, stack 40 may be in the form of an arc. At flat portion 52, stack 40 is flat. Flat portion 52 is sandwiched between two curved portions 51. Flat portion 52 connects two curved portions 51 to each other. It should be noted that electrode assembly 50 of the stacked type consists essentially of flat portion 52.

In electrode assembly 50, positive electrode plate 10 may have any number of layers. The number of the layers of positive electrode plate 10 represent the number of times a straight line extending across electrode assembly 50 in a layering direction intersects positive electrode plate 10. The layering direction represents a direction in which positive electrode plate 10, negative electrode plate 20, and separator 30 are layered in electrode assembly 50. The layering direction in electrode assembly 50 of the wound type is parallel to the thickness direction (D axis direction in FIG. 3) of each of positive electrode plate 10, negative electrode plate 20, and separator 30 in flat portion 52. The layering direction in electrode assembly 50 of the stacked type is parallel to the thickness direction of each of positive electrode plate 10, negative electrode plate 20, and separator 30.

The number of the layers of positive electrode plate 10 may be 60 to 80, for example. The number of layers of negative electrode plate 20 may be 60 to 80, for example. The number of layers of separator 30 may be 120 to 160, for example. The number of the layers of negative electrode plate 20 and the number of the layers of separator 30 can be also counted in the same manner as the number of the layers of positive electrode plate 10. It should be noted that when electrode assembly 50 is the stacked type, the number of the layers of positive electrode plate 10, the number of the layers of negative electrode plate 20, and the number of the layers of separator 30 represent the number of positive electrode plates 10, the number of negative electrode plates 20, and the number of separators 30, respectively.

In electrode assembly 50, the winding or stacking can be performed such that the length of each of the positive electrode active material layer and the negative electrode active material layer in the width direction (W axis direction in FIG. 1) of the electrode assembly is, for example, 180 mm or more, 200 mm or more, or 220 mm or more. That is, the length of each of the positive electrode active material layer and the negative electrode active material layer in the width direction of the electrode assembly when the positive electrode active material layer and the negative electrode active material layer are stacked or wound to form the electrode assembly can be, for example, 180 mm or more, 200 mm or more, or 220 mm or more.

Positive electrode plate 10 includes a positive electrode core body 11 and a positive electrode active material layer 12 (see FIG. 2). Positive electrode core body 11 is an electrically conductive sheet. Positive electrode core body 11 may include, for example, a pure Al foil, a Al alloy foil, or the like. Positive electrode core body 11 may have a thickness of, for example, 10 to 30 μm. Positive electrode core body 11 may be exposed at one end portion in the width direction of positive electrode plate 10 (W axis direction in FIG. 2). Positive electrode current collecting member 71 can be joined to the exposed portion of positive electrode core body 11 (see FIG. 1).

Positive electrode active material layer 12 may be disposed only on one surface of positive electrode core body 11. Positive electrode active material layer 12 may be disposed on each of the front and rear surfaces of positive electrode core body 11. The thickness of positive electrode active material layer 12 represents the total of the thickness(es) of positive electrode active material layer(s) 12 included in stack 40. For example, when positive electrode active material layers 12 are formed on the both surfaces of positive electrode plate 10, the thickness of positive electrode active material layer 12 represents the total of the thicknesses of positive electrode active material layers 12 on the both surfaces (two surfaces) thereof. Positive electrode active material layer 12 may have a thickness of 100 μm or more and 260 μm or less, may have a thickness of 20 to 60 μm, or may have a thickness of 30 to 50 μm, for example. It should be noted that the thickness of positive electrode active material layer 12 on one surface thereof may be 10 to 30 μm or may be 15 to 25 μm, for example.

Positive electrode active material layer 12 includes positive electrode active material particles. Each of the positive electrode active material particles can include any component. For example, each of the positive electrode active material particles may include at least one selected from a group consisting of LiCoO₂, LiNiO₂, LiMnO₂, LiMn₂O₄, Li(NiCoMn)O₂, Li(NiCoAl)O₂, and LiFePO₄. For example, in a composition formula such as “Li(NiCoMn)O₂”, the total of the composition ratios in the parentheses is 1. That is, the relation “C_{Ni}+C_{Co}+C_{Mn}=1” is satisfied. For example, “C_{Ni}” represents a composition ratio of Ni. Any composition ratio of each component is employed as long as the total of the composition ratios is 1.

Positive electrode active material layer 12 may further include a conductive material, a binder, an additive agent, and the like in addition to the positive electrode active material particles. For example, positive electrode active material layer 12 may consist essentially of 0.1 to 10% of the conductive material in mass fraction, 0.1 to 10% of the binder in mass fraction, and a remainder of the positive electrode active material particles. The conductive material may include, for example, acetylene black or the like. The binder can include any component. The binder may include, for example, polyvinylidene difluoride (PVdF) or the like. Details of the additive agent will be described later.

Separator 30 includes a porous resin layer. Separator 30 may consist essentially of a porous resin layer. The porous resin layer is in direct contact with negative electrode active material layer 22. Since no object is interposed between the porous resin layer and negative electrode active material layer 22, it is expected to attain an improved output or the like, for example. It should be noted that separator 30 may or may not include a protective layer on its surface to be in contact with positive electrode active material layer 12.

The porous resin layer may have a thickness of 10 to 50 μm, may have a thickness of 10 to 30 μm, or may have a thickness of 14 to 20 μm, for example.

The porous resin layer has an electrical insulation property. The porous resin layer includes a polyolefin-based material. The porous resin layer may consist essentially of the polyolefin-based material, for example. The polyolefin-based material may include, for example, at least one selected from a group consisting of polyethylene (PE) and polypropylene (PP).

Negative electrode plate 20 includes a negative electrode active material layer 22 (see FIG. 2). Negative electrode plate 20 may consist essentially of negative electrode active material layer 22. Negative electrode plate 20 may further include a negative electrode core body 21, for example. For example, negative electrode active material layer 22 may be disposed on a surface of negative electrode core body 21. Negative electrode active material layer 22 may be disposed only on one surface of negative electrode core body 21. Negative electrode active material layer 22 may be disposed on each of both front and rear surfaces of negative electrode core body 21. Negative electrode core body 21 is an electrically conductive sheet. Negative electrode core body 21 may include, for example, a pure Cu foil, a Cu alloy foil, or the like. Negative electrode core body 21 may have a thickness of, for example, 5 to 30 μm. Negative electrode core body 21 may be exposed at one end portion in the width direction of negative electrode plate 20 (W axis direction in FIG. 2). Negative electrode current collecting member 72 can be joined to the exposed portion of negative electrode core body 21 (see FIG. 1).

The thickness of stack 40 represents the total of the thicknesses of positive electrode plate 10, negative electrode plate 20 and separator 30 included in stack 40. Stack 40 may have a thickness of 100 to 200 μm or may have a thickness of 120 to 180 μm, for example.

The thickness of negative electrode active material layer 22 represents the total of the thickness(es) of negative electrode active material layer(s) 22 included in stack 40. For example, when negative electrode active material layers 22 are formed on the both surfaces of negative electrode plate 20, the thickness of negative electrode active material layer 22 represents the total of the thicknesses of negative electrode active material layers 22 on the both surfaces (two surfaces) thereof. Negative electrode active material layer 22 may have a thickness of 100 μm or more and 260 μm or less, may have a thickness of 40 to 80 μm, or may have a thickness of 50 to 70 μm, for example. It should be noted that the thickness of negative electrode active material layer 22 on one surface thereof may be 20 to 40 μm or may be 25 to 35 μm, for example.

Negative electrode active material layer 22 includes negative electrode active material particles. Negative electrode active material layer 22 may consist essentially of the negative electrode active material particles. Each of the negative electrode active material particles may include at least one selected from a group consisting of natural graphite, artificial graphite, silicon, silicon oxide, tin, tin oxide, and Li₄Ti₅O₁₂, for example. The negative electrode active material particle may be a composite particle, for example. The negative electrode active material particle may include, for example, a substrate particle and a coating film. The coating film can coat a surface of the substrate particle. The substrate particle may include natural graphite or the like, for example. The coating film may include, for example, amorphous carbon or the like.

Negative electrode active material layer 22 may further include a conductive material, a binder, an additive agent, and the like in addition to the negative electrode active material particles. For example, negative electrode active material layer 22 may consist essentially of 0 to 10% of the conductive material in mass fraction, 0.1 to 10% of the binder in mass fraction, and a remainder of the negative electrode active material particles. The conductive material can include any component. The conductive material may include, for example, carbon black, carbon nanotube, or the like. The binder can include any component. The binder may include, for example, at least one selected from a group consisting of carboxymethyl cellulose (CMC) and styrene-butadiene rubber (SBR). Details of the additive agent will be described later.

The electrolyte solution is a liquid electrolyte. The electrolyte solution includes a solvent, a lithium salt (hereinafter also referred to as Li salt), and an additive agent. The solvent is aprotic. The solvent can include any component. The solvent may include, for example, at least one selected from a group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The Li salt is dissolved in the solvent. The Li salt may include, for example, at least one selected from a group consisting of LiPF₆, LiBF₄, and LiN(FSO₂)₂. The Li salt may have a molar concentration of, for example, 0.2 to 2.0 M (mol/L).

The additive agent includes at least one selected from a group consisting of LiBOB and LiFSO₃. The electrolyte solution may include 0.01 to 5% of the additive agent in mass fraction. When each of the positive electrode active material layer and the negative electrode active material layer includes the additive agent, the additive agent can be the additive agent in the electrolyte solution. The electrolyte solution permeates into each of the positive electrode active material layer and the negative electrode active material layer, with the result that the additive agent is included in each of the positive electrode active material layer and the negative electrode active material layer.

At least one of the positive electrode active material layer and the negative electrode active material layer includes a component originated from the additive agent. In at least one of the positive electrode active material layer and the negative electrode active material layer, a ratio A/B of a concentration A of the component originated from the additive agent in a region (hereinafter also referred to as an end-portion region) disposed on the end portion side in the width direction of the electrode assembly (hereinafter also referred to as an end-portion additive agent concentration A) to a concentration B of the component originated from the additive agent in a region (hereinafter also referred to as a central region) disposed in a central portion in the width direction of the electrode assembly (hereinafter also referred to as a central-portion additive agent concentration B) is 1.4 or more and 2.6 or less. Since the ratio A/B is 1.4 or more and 2.6 or less in at least one of the positive electrode active material layer and the negative electrode active material layer, reaction due to heat generation at the central portion is suppressed to attain uniform reaction between the end-portion-side portion and the central portion in the width direction, with the result that deterioration of the cell property can be suppressed when performing charging/discharging. The ratio A/B is preferably 1.4 or more and 2.0 or less, and is more preferably 1.4 or more and 1.8 or less. There is no or a very small difference of the ratio A/B in the stacking direction.

In the case of the wound type electrode assembly obtained by winding the stack having the strip shape, the width direction of the electrode assembly is a direction parallel to the winding axis, whereas in the case of the stacked type electrode assembly having the quadrangular planar shape, the width direction of the electrode assembly is a longer one of directions that each connects opposing end portions in the shortest distance when the electrode assembly is viewed in the stacking direction. In FIG. 1, the width direction of electrode assembly 50 is the W axis direction. The region disposed in the central portion of each of the positive electrode active material layer and the negative electrode active material layer in the width direction of the electrode assembly can be a region that includes the center in the width direction of the electrode assembly, wherein a length of the region in the width direction of the electrode assembly when the above-described center is regarded as its center is 10% of a length, in the width direction of the electrode assembly, of a portion at which the positive electrode active material layer and the negative electrode active material layer face each other. Further, the region disposed on the end portion side of each of the positive electrode active material layer and the negative electrode active material layer in the width direction of the electrode assembly can be a region that includes an end portion in the width direction of the electrode assembly, wherein a length of the region in the width direction of the electrode assembly is 10% of the length, in the width direction, of the portion at which the positive electrode active material layer and the negative electrode active material layer face each other.

Each of end-portion additive agent concentration A and central-portion additive agent concentration B may be an average value of concentrations of the component originated from additive agent as measured at ten positions in each of the central region and end-portion region of each of the positive electrode active material layer and the negative electrode active material layer. The component originated from the additive agent can be, for example, S and B. Each of end-portion additive agent concentration A and central-portion additive agent concentration B is found as a mass ratio (%) of the component originated from the additive agent and included in the positive electrode active material layer or the negative electrode active material layer per unit volume based on the mass of the positive electrode active material layer or the negative electrode active material layer per unit volume as a reference. The mass ratio (%) can be measured, for example, by laser ablation ICP mass spectrometry (LA-ICP-MS). For example, when the electrode assembly is the wound type electrode assembly, each of end-portion additive agent concentration A and central-portion additive agent concentration B is measured in accordance with a method described in the below-described section “Examples”.

### EXAMPLES

Hereinafter, the present invention will be described in more detail with reference to examples. “%” and “parts” in the examples are mass % and parts by mass unless otherwise stated particularly.

### Example 1

### [Production of Positive Electrode Plate]

A positive electrode slurry produced by mixing a positive electrode active material layer formation composition (LiNiCoMnO₂:AB:PVdF=100:1:1 in mass ratio) and NMP was applied onto an aluminum foil (positive electrode core body), which was dried, was then compressed to a predetermined thickness, and was cut into a predetermined width, thereby producing a positive electrode plate constituted of a portion in which a positive electrode active material layer was formed on the aluminum foil in the width direction and a portion in which no active material layer was formed thereon in the width direction. The length of the positive electrode active material layer (thickness: 110 μm) in the width direction of the electrode assembly (hereinafter also referred to as the width of the positive electrode active material layer) was 220 mm.

### [Production of Negative Electrode Plate]

A negative electrode slurry produced by mixing a negative electrode active material layer formation composition (graphite:SBR:CMC=100:1:1 in mass ratio) and water was applied onto a copper foil (negative electrode core body), which was dried, was then compressed to a predetermined thickness, and was cut into a predetermined width, thereby producing a negative electrode plate constituted of a portion in which a negative electrode active material layer was formed on the copper foil and a portion in which no negative electrode active material layer was formed thereon. The length of the negative electrode active material layer (thickness: 140 μm) in the width direction of the electrode assembly (hereinafter also referred to as the width of the negative electrode active material layer) was 224 mm.

### [Production of Electrode Assembly]

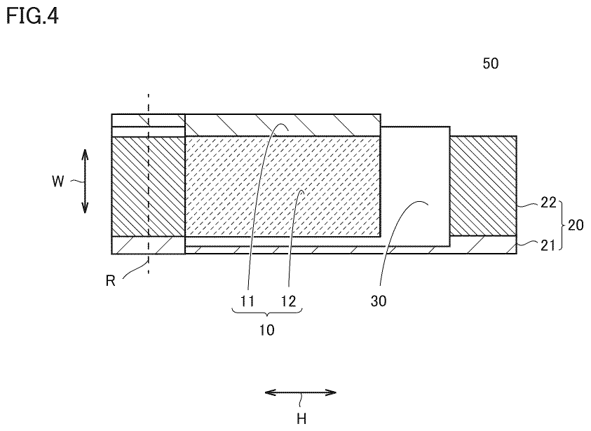

As shown in FIG. 4, a stack was produced by stacking positive electrode plate 10 and negative electrode plate 20 with separator 30, which is composed of three layers of polypropylene/polyethylene/polypropylene, being interposed therebetween such that the aluminum foil of the positive electrode plate and the copper foil of the negative electrode plate were exposed at respective end portions, and the stack was wounded with one end of the stack regarded as a winding axis R, thereby producing a wound type electrode assembly 50.

### [Production of Non-Aqueous Electrolyte Secondary Battery]

The aluminum foil of the positive electrode plate of the electrode assembly and the aluminum plate of the positive electrode current collecting member were welded to each other, the copper foil of the negative electrode plate of the electrode assembly and the copper plate of the negative electrode current collecting member were welded to each other, they were inserted into an exterior package of an aluminum laminate film, an electrolyte solution was injected in accordance with the following electrolyte solution injection method 1, and the laminate film was sealed, thereby preparing a non-aqueous electrolyte secondary battery.

### [Electrolyte Solution Injection Method 1]

After injecting a first electrolyte solution [1.4M_LiPF₆ EC/EMC (volume ratio of 1:3) and an additive agent: LiBOB_1 wt %], it was then left for 1 hour, was then charged at a current value of 0.05 C. under a 25° C. environment until 2.5 V was attained, and was left for 1 hour. Next, a second electrolyte solution [0.6M_LiPF₆ EC/EMC (volume ratio of 1:3) and no additive agent] was injected and it was left for 3 hours. The first electrolyte solution and the second electrolyte solution were injected to attain a volume ratio of 50 volume %:50 volume %.

### Comparative Example 1

A non-aqueous electrolyte secondary battery of a Comparative Example 1 was produced in the same manner as in Example 1 except that the following electrolyte solution injection method 2 was performed instead of electrolyte solution injection method 1 in Example 1.

### [Electrolyte Solution Injection Method 2]

After injecting a third electrolyte solution [1.0M_LiPF₆ EC/EMC (volume ratio of 1:3) and an additive agent: LiBOB_0.5 wt %] at a volume ratio of 100%, it was left for 3 hours, was then charged at a current value of 0.05 C under a 25° C. environment until 2.5 V was attained, and was left for 1 hour.

### Comparative Example 2

A non-aqueous electrolyte secondary battery of a Comparative Example 2 was produced in the same manner as in Example 1 except that instead of the first electrolyte solution and the second electrolyte solution in Example 1, a fourth electrolyte solution [1.2M_LiPF₆ EC/EMC (volume ratio of 1:3) and an additive agent: LiBOB_1 wt %] and a fifth electrolyte solution [0.8M_LiPF₆ EC/EMC (volume ratio of 1:3) and no additive agent] were used.

### Example 2

A non-aqueous electrolyte secondary battery of an Example 2 was produced in the same manner as in Example 1 except that instead of the first electrolyte solution and the second electrolyte solution in Example 1, a sixth electrolyte solution [1.6M_LiPF₆ EC/EMC (volume ratio of 1:3) and an additive agent: LiBOB_1 wt %] and a seventh electrolyte solution [0.4M_LiPF₆ EC/EMC (volume ratio of 1:3) and no additive agent] were used.

### Example 3

A non-aqueous electrolyte secondary battery of an Example 3 was produced in the same manner as in Example 1 except that instead of the first electrolyte solution and the second electrolyte solution in Example 1, an eighth electrolyte solution [1.8M_LiPF₆ EC/EMC (volume ratio of 1:3) and an additive agent: LiBOB_1 wt %] and a ninth electrolyte solution [0.2M_LiPF₆ EC/EMC (volume ratio of 1:3) and no additive agent] were used.

### Comparative Example 3

A non-aqueous electrolyte secondary battery of a Comparative Example 3 was produced in the same manner as in Example 1 except that instead of the first electrolyte solution and the second electrolyte solution in Example 1, a tenth electrolyte solution [2.0M_LiPF₆ EC/EMC (volume ratio of 1:3) and an additive agent: LiBOB_1 wt %] and an eleventh electrolyte [no LiPF₆ EC/EMC (volume ratio of 1:3) and no additive agent] were used.

### Comparative Example 4

A non-aqueous electrolyte secondary battery of a Comparative Example 4 was produced in the same manner as in Example 1 except that the width of the positive electrode active material layer was 130 mm and the width of the negative electrode active material layer was 134 mm.

### Example 4

A non-aqueous electrolyte secondary battery of an Example 4 was produced in the same manner as in Example 3 except that the width of the positive electrode active material layer was 130 mm and the width of the negative electrode active material layer was 134 mm.

### Comparative Example 5

A non-aqueous electrolyte secondary battery of a Comparative Example 5 was produced in the same manner as in Example 1 except that the width of the positive electrode active material layer was 180 mm, the width of the negative electrode active material layer was 184 mm, and electrolyte solution injection method 2 was performed.

### Example 5

A non-aqueous electrolyte secondary battery of an Example 5 was produced in the same manner as in Example 2 except that the width of the positive electrode active material layer was 180 mm and the width of the negative electrode active material layer was 184 mm.

### Comparative Example 6

A non-aqueous electrolyte secondary battery of a Comparative Example 6 was produced in the same manner as in Comparative Example 1 except that instead of the third electrolyte solution in Comparative Example 1, a twelfth electrolyte solution [10M_LiPF₆ EC/EMC (volume ratio of 1:3) and an additive agent: LiFSO₃_0.5 wt %] was used.

### Example 6

A non-aqueous electrolyte secondary battery of an Example 6 was produced in the same manner as in Example 1 except that instead of the first electrolyte solution and the second electrolyte solution in Example 1, a thirteenth electrolyte solution [1.4M_LiPF₆ EC/EMC (volume ratio of 1:3) and an additive agent: LiFSO₃_1 wt %] and a fourteenth electrolyte solution [0.6M_LiPF₆ EC/EMC (volume ratio of 1:3) and no additive agent] were used.

### <Initial Activation of Non-Aqueous Electrolyte Secondary Battery>

In a 25° C. environment, each of the non-aqueous electrolyte secondary batteries produced in the Examples and the Comparative Examples was repeatedly subjected to three charging/discharging cycles of charging with 4.2 Vcccv at a current value of C/10 and discharging at a current value of C/10 until 3 V was attained, was retained at 60° C. for 24 hours in a state in which charging has been made until 4.2 V was attained, and was discharged at a current value of C/10 until 3 V was attained, thereby performing initial activation.

### <Measurement of Additive Agent Component Concentrations A and B>

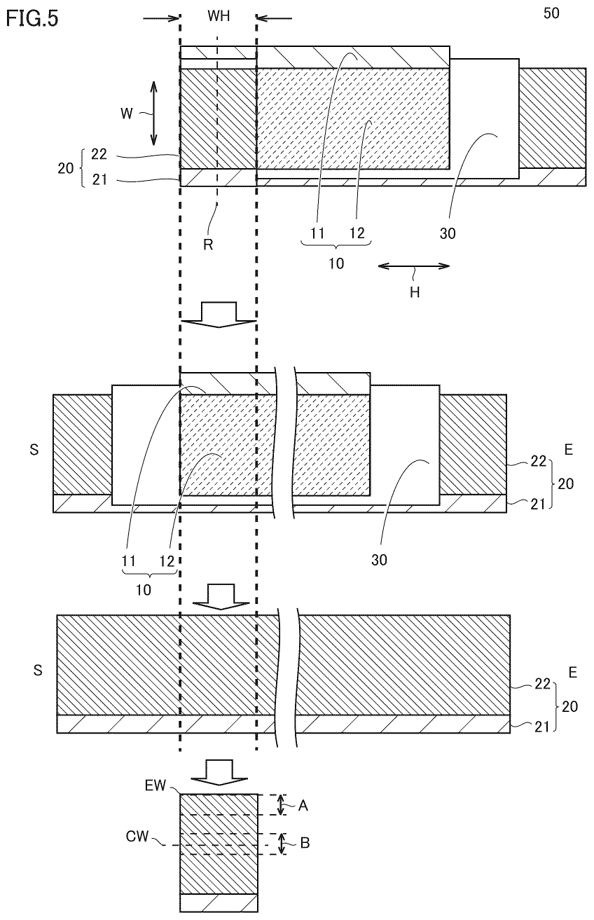

As shown in FIG. 5, each of the non-aqueous electrolyte secondary batteries having been through the initial activation was disassembled to extract the electrode assembly, the extracted electrode assembly was expanded from the winding end (E) to the winding start (S) of the extracted electrode assembly, and a portion, facing the inner peripheral side, of the first turn of the positive electrode plate at the winding start (S) of the electrode assembly was cut out from the expanded negative electrode plate. The negative electrode plate having been cut out was cleaned with dimethyl carbonate (DMC), was then dried under a reduced pressure, and was subjected to the following quantitative analysis, thereby measuring the additive agent component concentrations. For B representing the LiBOB component or S representing the LiFSO₃ component, laser ablation ICP mass spectrometry (LA-ICP-MS) was employed to define an end-portion additive agent component concentration A as the average value of the measured component in a range (end-portion region) (A) from the end portion (EW) in the width direction (W) of the electrode assembly to a length of 10% of the width (WH) of the negative electrode plate facing the positive electrode plate, and define a central-portion additive agent component concentration B as the average value of the above-described measured component in a range (central region) (B) from the center (CW) of the negative electrode active material layer in the width direction (W) of the electrode assembly to the length of 10% of the width (WH) of the negative electrode plate facing the positive electrode plate. A ratio of central-portion additive agent component concentration B when end-portion additive agent component concentration A is regarded as 100% is shown in Table 1 as a ratio A/B.

### <Evaluation on Cycle Capacity Retention>

After the initial activation, the following cycle test was performed. Under a 25° C. environment, charging and discharging were repeatedly performed while regarding, as one cycle, charging with 4.2 Vcccv at a current value of 1 C and discharging at a current value of 1 C until 3 V was attained. A retention of the discharging capacity in the 500th cycle with respect to the discharging capacity in the first cycle was defined as the capacity retention. The capacity retention is calculated by the following formula:

Capacity retention=(discharging capacity in the 500th cycle/discharging capacity in the first cycle)×100(%).

Results are shown in Table 1.

TABLE 1

| | | | Additive Agent | | | |
|---|---|---|---|---|---|---|
| | Positive | | Component | | | |
| | Electrode | | Concentration in | | | Cycle |
| | Active | | Negative Electrode | | | Ca- |
| | Material | Additive | End | Central | | pacity |
| | Layer | Agent in | Portion | Portion | | Reten- |
| | Width | Electrolyte | (%) | (%) | | tion |
| Examples | mm | Solution | A | B | A/B | (%) |
| Comparative | 220 | LiBOB | 100 | 97 | 1.0 | 82 |
| Example 1 | | | | | | |
| Comparative | 220 | LiBOB | 100 | 83 | 1.2 | 85 |
| Example 2 | | | | | | |
| Example 1 | 220 | LiBOB | 100 | 69 | 1.4 | 87 |
| Example 2 | 220 | LiBOB | 100 | 44 | 2.3 | 88 |
| Example 3 | 220 | LiBOB | 100 | 38 | 2.6 | 87 |
| Comparative | 220 | LiBOB | 100 | 30 | 3.3 | 83 |
| Example 3 | | | | | | |
| Comparative | 130 | LiBOB | 100 | 98 | 1.0 | 90 |
| Example 4 | | | | | | |
| Example 4 | 130 | LiBOB | 100 | 63 | 1.6 | 91 |
| Comparative | 180 | LiBOB | 100 | 96 | 1.0 | 85 |
| Example 5 | | | | | | |
| Example 5 | 180 | LiBOB | 100 | 58 | 1.7 | 90 |
| Comparative | 220 | LiFSO3 | 100 | 96 | 1.0 | 83 |
| Example 6 | | | | | | |
| Example 6 | 220 | LiFSO3 | 100 | 63 | 1.6 | 89 |

In each of Examples 1 to 3, 4 and 5, the ratio A/B was 1.4 or more and 2.6 or less. In view of this, it is presumed that the salt concentration of the electrolyte solution at the first time of the injection is increased to cause a high viscosity of the electrolyte solution, which leads to a slow impregnation speed of the electrolyte solution in the width direction of the electrode assembly to result in a relatively long time for which the electrolyte solution stays in the vicinity of the end portion, and charging was performed in this state until 2.5 V was attained so as to form a coating film on the surface of the negative electrode active material by reduction and decomposition of LiBOB, with the result that the concentration of the additive agent component on the end portion side is relatively higher than that in the central portion. In a comparison between each of Comparative Examples 1 and 2 and each of Examples 1 to 3, it was found that the cycle capacity retention tends to be higher as the ratio A/B becomes larger. Further, in each of Examples 1 and 2, the cycle capacity retention was improved by 5% or more as compared with Comparative Example 1, thereby obtaining a sufficient effect. In view of these, one factor for decreased cycle capacity retention is presumably as follows: the effect of reducing the reaction resistance of the negative electrode active material can be obtained by the initial activation of the additive agent LiBOB; however, since the additive agent component concentration in the width direction is substantially uniform in Comparative Example 1, the resistance in the width direction is the same but when the temperature in the vicinity of the central portion is increased to be higher than that on the end portion side of the battery due to the charging/discharging cycle, the reaction resistance in the vicinity of the central portion is further decreased and is therefore decreased as compared with that in the vicinity of the end portion to facilitate the current to concentrate in the vicinity of the central portion during the cycle, thereby causing unevenness in reaction. On the other hand, the cycle capacity retention is improved presumably due to the following reason: as the concentration of the additive agent component on the end portion side with respect to that in the central portion is increased, the resistance in the central portion is initially higher than the resistance in the vicinity of the end portion; however, by the charging/discharging cycle, the resistance in the central portion is decreased due to the temperature increase therein, thereby suppressing a difference of the resistance in the central portion from that on the end portion side. As a result, it is presumed that the cycle capacity retention is improved in each of Examples 1 and 2 as compared with Comparative Example 1. When the additive agent component concentration ratio becomes further higher as in each of Example 3 and Comparative Example 3 than that of Example 2, the cycle capacity retention tends to be conversely decreased and the cycle capacity retention in Comparative Example 3 is about the same as that of Comparative Example 1. These are presumed to be caused highly likely due to the following factor: the resistance difference between the end portion side and the central portion in the initial state is too large. In comparison between Comparative Example 4 and Example 4, it is presumed that since the width of the positive electrode active material layer is 130 mm, i.e., is narrower than those of Examples 1 to 3, a temperature difference in the width direction due to the cycle test is relatively less likely to occur, with the result that the influence of the above-described factor over the cycle capacity retention is small. In comparison between Example 5 and Comparative Example 5, the cycle capacity retention was improved by 5% by increasing the ratio A/B. These are presumably due to the effect of improving the cycle capacity retention by the above-described factor. In view of comparison between Example 6 and Comparative Example 6, it is presumed that the effect of reducing the reaction resistance of the negative electrode active material is obtained also with LiFSO₃, thereby improving the cycle capacity retention by the same factor as in the other examples. In view of the above, it is understood that according to the present invention, there is provided a non-aqueous electrolyte secondary battery to suppress deterioration of a cell property when repeatedly charged and discharged.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A non-aqueous electrolyte secondary battery comprising an electrode assembly and an electrolyte solution, wherein
the electrode assembly includes a positive electrode plate, a separator, and a negative electrode plate,
the electrolyte solution contains a lithium salt, a solvent, and an additive agent,
the positive electrode plate includes a positive electrode core body and a positive electrode active material layer,
the negative electrode plate includes a negative electrode core body and a negative electrode active material layer, and
in at least one of the positive electrode active material layer and the negative electrode active material layer, a ratio A/B of a concentration A of a component originated from the additive agent in a region disposed on an end portion side in a width direction of the electrode assembly to a concentration B of the component originated from the additive agent in a region disposed in a central portion in the width direction of the electrode assembly is 1.4 or more and 2.6 or less.

2. The non-aqueous electrolyte secondary battery according to claim 1, wherein a length of each of the positive electrode active material layer and the negative electrode active material layer in the width direction of the electrode assembly is 180 mm or more.

3. The non-aqueous electrolyte secondary battery according to claim 1, wherein the additive agent includes at least one selected from a group consisting of LiBOB and LiFSO₃.

4. The non-aqueous electrolyte secondary battery according to claim 1, wherein at least one of the positive electrode active material layer and the negative electrode active material layer includes the additive agent.

5. The non-aqueous electrolyte secondary battery according to claim 1, wherein a thickness of each of the positive electrode active material layer and the negative electrode active material layer is 100 μm or more and 260 μm or less.

6. The non-aqueous electrolyte secondary battery according to claim 1, wherein the electrode assembly is a wound type.

7. The non-aqueous electrolyte secondary battery according to claim 1, wherein the electrode assembly is a stacked type.
